(19) United States
(12) Patent Application Publication
(10) Pub. No.: US 2018/0330361 A1
(43) Pub. Date: Nov. 15, 2018

(54) PAYMENT ACCOUNT SYSTEM TRANSACTION NOTIFICATION AND REPORTING METHODS AND APPARATUS

(71) Applicant: MasterCard International Incorporated, Purchase, NY (US)

(72) Inventors: Antonio Marra, Fishkill, NY (US); Saurabh Mehta, White Plains, NY (US); Joseph Zeltzer, Hoboken, NJ (US)

(21) Appl. No.: 15/590,296

(22) Filed: May 9, 2017

(51) Int. Cl. G06Q 20/32; G06Q 20/10; G06F 17/30; G06F 21/35; G06Q 20/20; G06Q 20/36; G06Q 30/06

(52) U.S. Cl. CPC G06Q 20/3274; G06Q 20/3226; G06Q 20/102; G06Q 20/3276; G06Q 30/0601; G06F 21/35; G06Q 20/20; G06Q 20/363; G06F 17/30879

(57) ABSTRACT

A QR (quick response) code is scanned by a customer's payment-enabled mobile device to launch a payment account system transaction. The QR code includes the mobile phone number for a merchant's employee or associate. The mobile phone number is communicated through payment account system transaction messaging to the merchant's bank. The merchant's bank sends a confirmation message to the employee/associate to trigger completion of a related purchase transaction.

### BACKGROUND

It has been proposed to launch a payment account system transaction by having a customer's payment-enabled smartphone scan a QR (quick response) code.

However, the complexity of some retail operations presents challenges that may not be fully satisfied by existing modes of payment account system communication if applied to payment account system transactions initiated via scanning of QR codes.

### BRIEF DESCRIPTION OF THE DRAWINGS

Features and advantages of some embodiments of the present disclosure, and the manner in which the same are accomplished, will become more readily apparent upon consideration of the following detailed description taken in conjunction with the accompanying drawings, which illustrate preferred and exemplary embodiments and which are not necessarily drawn to scale, wherein:

FIG. 1 is a block diagram that illustrates a conventional payment account system.

FIG. 2 is a block diagram that illustrates aspects of an environment in which teachings of this disclosure may be applied.

FIG. 3 is a simplified block diagram of a payment account system according to aspects of the present disclosure.

FIG. 4 is a block diagram that shows some features of a typical mobile device that may perform a role in the payment account system illustrated in FIG. 3.

FIG. 5 is a block diagram that illustrates a computer system that may perform a role in the payment account system illustrated in FIG. 3.

FIGS. 6 and 7 are flow charts that illustrate processes that may be performed in accordance with aspects of the present disclosure.

### DETAILED DESCRIPTION

In general, and to introduce concepts of embodiments of this disclosure, a payment account system may be adapted to support QR-based transactions in merchant environments having individual associates (or “sub-merchants”) who require notification of individual transaction completion in real time. Merchant reporting needs with respect to individual associates may also be supported.

The QR code may be presented from the merchant's associate for scanning by the customer's mobile device. The QR code may include a mobile telephone number that corresponds to the associate's mobile phone. In scanning the QR code, the customer's mobile device may acquire the associate's mobile phone number, to be forwarded with the transaction request to the customer's bank (the “origination institution”). The origination institution may execute a “push” payment account system transaction to the merchant's bank (the “receiving institution”). The push transaction messaging to the receiving institution may include the associate's mobile phone number. The receiving institution may use the associate's mobile phone number to send a notification text message or the like to the associate's mobile phone so that the purchase transaction can be consummated/completed.

In the current discussion, the terms “user”, “consumer”, “customer” and “account holder” will be used interchangeably.

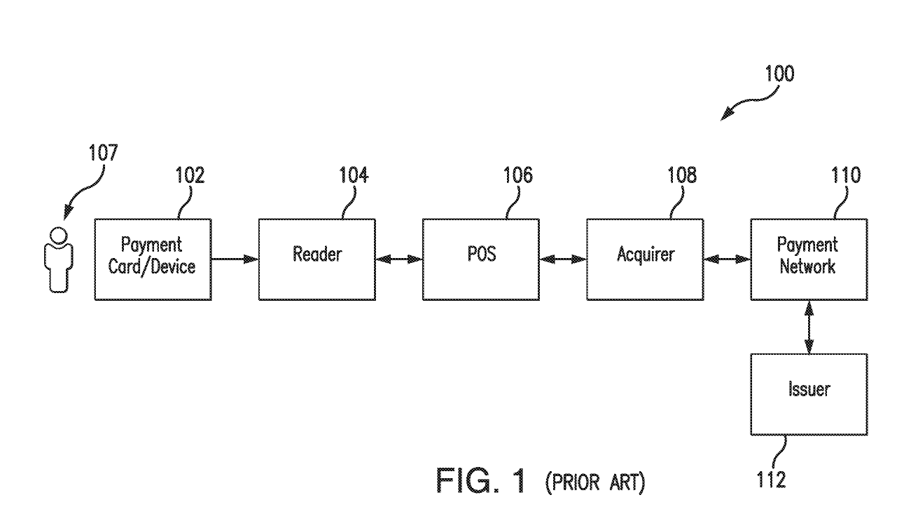

FIG. 1 is a block diagram that illustrates a conventional payment account system 100.

The system 100 includes a conventional payment card/device 102 (which may alternatively be, for example, a payment IC card or a payment-enabled mobile device that stores a payment card account number or payment token and runs a payment/wallet app). The system 100 further includes a reader component 104 associated with a POS terminal 106. In some known manner (depending on the type of the payment card/device 102) the reader component 104 is capable of reading the payment card account number/payment token and other information from the payment card/device 102.

The reader component 104 and the POS terminal 106 may be located at the premises of a retail store and operated by a sales associate of the retailer for the purpose of processing retail transactions. The payment card/device 102 is shown in FIG. 1 to be interacting with the reader component 104 and the POS terminal 106 for the purpose of executing such a transaction. Reference numeral 107 indicates a user/account holder who is a customer at the retail store and who has presented the payment card/device 102 to the reader component in order to settle the retail transaction.

A computer 108 operated by an acquirer (acquiring financial institution; sometimes referred to as a “transaction acquirer”) is also shown as part of the system 100 in FIG. 1. The acquirer computer 108 may operate in a conventional manner to receive a payment account system transaction authorization request message (sometimes referred to as an “authorization request”) for the transaction from the POS terminal 106. The acquirer computer 108 may route the authorization request via a payment network 110 to the server computer 112 operated by the issuer of a payment account that is associated with the payment card/device 102. As is also well known, the payment account system transaction authorization response message (also referred to as an “authorization response”) generated by the payment account issuer server computer 112 may be routed back to the POS terminal 106 via the payment network 110 and the acquirer computer 108.

One well known example of a payment network is referred to as the “Banknet” system, and is operated by MasterCard International Incorporated, which is the assignee hereof.

The payment card issuer server computer 112 may be operated by or on behalf of a financial institution (“FI”) that issues payment accounts to individual users and other entities. For example, the payment account issuer server computer 112 may perform such functions as (a) receiving and responding to requests for authorization of payment account transactions to be charged to payment accounts issued by the FI; and (b) tracking and storing transactions and maintaining account records.

The components of the system 100 as depicted in FIG. 1 are only those that are needed for processing a single transaction. A typical payment account system may process many purchase transactions (including simultaneous transactions) and may include a considerable number of payment account issuers and their computers, a considerable number of acquirers and their computers, and numerous merchants and their POS terminals and associated reader components. The system may also include a very large number of payment account holders, who carry payment cards or other devices for initiating payment transactions by presenting an associated payment account number or token to the reader component of a POS terminal.

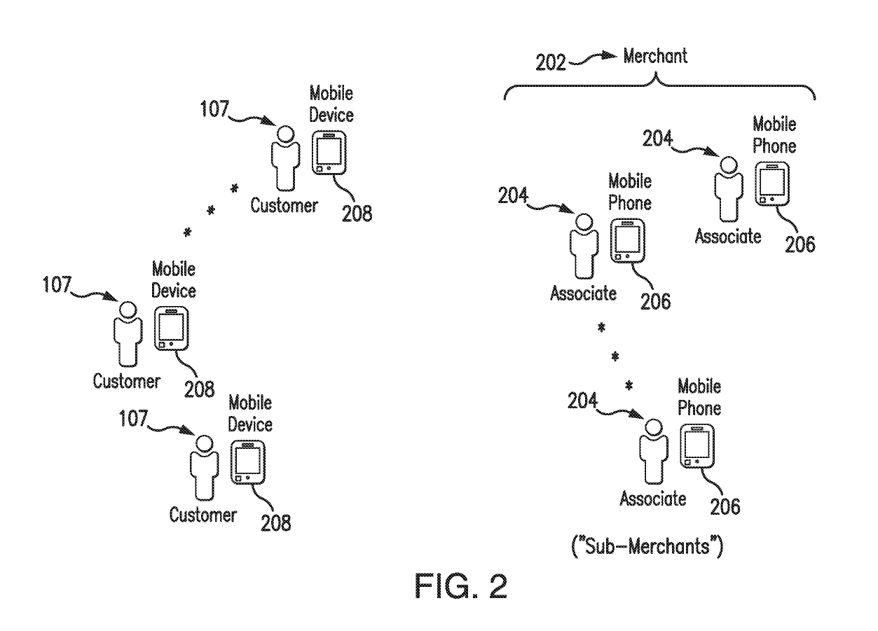

FIG. 2 is a block diagram that illustrates aspects of an environment in which teachings of this disclosure may be applied.

A merchant 202 is schematically shown in FIG. 2. The merchant is assumed to employ or make use of numerous associates (i.e., individuals, such as employees) 204, each of whom has possession of a mobile phone 206. The mobile phones may or may not be smartphones, and may be of various types. It is desirable however that all be addressable by mobile phone number and capable of receiving text messages or the like.

It is assumed that the associates 204 are involved from time to time (or frequently) in sales transactions on behalf of the merchant 202. As will be seen, the sales transactions may be settled via payment account system transactions, and from a system point of view, the associates 204 may be regarded as “sub-merchants” in service to the merchant 202, with the latter possibly referred to as a “super-merchant”.

Although numerous associates 204 are schematically indicated in FIG. 2, it may alternatively be the case that the merchant 202 only has a small number, perhaps only one, associate 204.

Also shown in FIG. 2 is a universe of customers/potential customers 107 who may at times engage in what the merchant 202 sees as sales transactions and what the customers 107 see as purchase transactions. Such transactions may or may not be on retail store premises (not explicitly shown) operated by the merchant 202. Each customer 107 is assumed to carry a payment-enabled mobile device 208. Details of an example payment-enabled mobile device 208 will be described below.

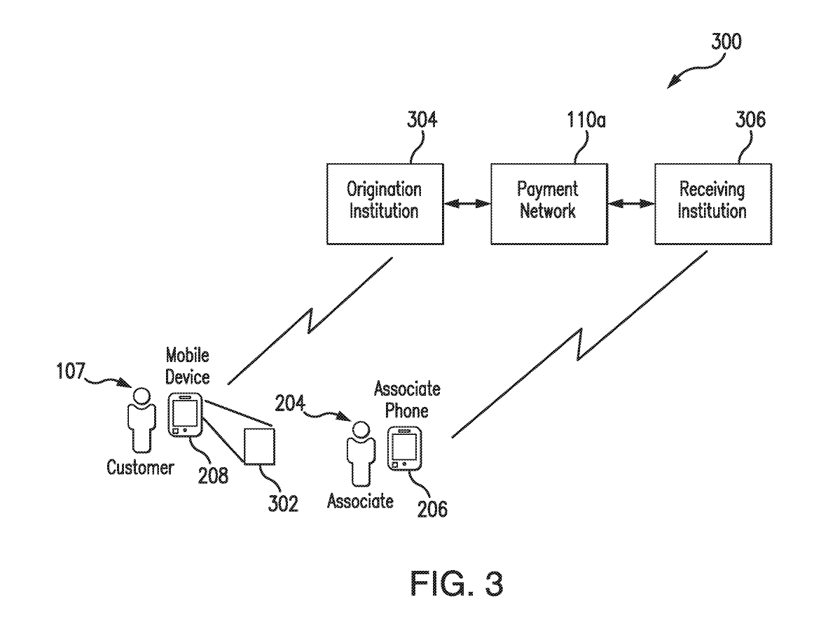

FIG. 3 is a simplified block diagram of a payment account system 300 according to aspects of the present disclosure.

In FIG. 3, one of the customers 107 from FIG. 2 is shown, with his/her mobile device 208. Also shown in FIG. 3 is one of the associates 204 from FIG. 2, with his/her mobile phone 206. In the depiction of FIG. 3, the associate 204 is presenting a QR code 302 for scanning by the customer's mobile device 208. (The associate 204 may be deemed to have “presented” the QR code 302 merely by being located or stationed nearby it.) As will be seen, the scanning of the QR code 302 is for the purpose of initiating a payment account system transaction to benefit a merchant (not shown in FIG. 3) that is being represented—in some fashion—by the associate 204. The mobile device 208, the mobile phone 206, and the QR code 302 may all be deemed components of the payment account system 300.

The payment account system 300 also includes an origination institution 304 (i.e., the issuer of the customer's payment account(s)), a payment network 110a, and a receiving institution 306 (i.e., a financial institution that provides payment account system transaction acquiring services to the merchant).

The payment network 110a need not necessarily be different from the payment network 110 referred to in connection of FIG. 1, except that particulars of data carried in transaction messages handled by the payment network 110a may differ from data typically found in the messaging described above in connection with FIG. 1.

It will be recalled that in a conventional transaction as illustrated in FIG. 1, the message flow may be characterized as: merchant 4 acquirer 4 network 4 issuer 4 network 4 acquirer 4 merchant. By contrast, in the “push” transaction illustrated in FIG. 3, the message flow may be considered reversed or redirected as compared to FIG. 1, and may be characterized as customer 4 origination institution (issuer) 4 network 4 receiving institution (acquirer). At the latter point, the payment account system transaction itself may be deemed complete, but with notification of the transaction immediately following via a message from the receiving institution to the associate (representing the merchant). More details will be provided below regarding example embodiments of the transaction illustrated in FIG. 3.

The blocks indicating entities 110a, 304 and 306 in FIG. 3 should also be understood to represent one or more computer systems respectively operated by or on behalf of the entities.

The components of the system 300 as depicted in FIG. 3 are only those that are needed for processing a single transaction. A practical embodiment of the payment account system 300 may process many transactions (including simultaneous transactions) and may include a considerable number of origination institutions and their computers, a considerable number of receiving institutions and their computers, and numerous associates and customers, with their mobile phones/devices as depicted schematically in FIG. 2. A considerable, quite large number of merchants may each be represented by a large or small universe of associates.

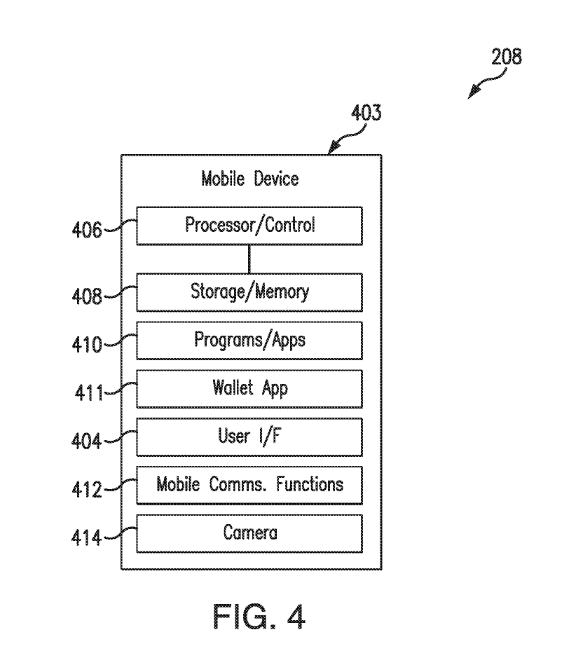

FIG. 4 is a block diagram that shows some features of a typical embodiment of a mobile device 208 shown in FIG. 2 or 3.

The mobile device 208 of FIG. 4 may include a housing 403. In many embodiments, the front of the housing 403 is predominantly constituted by a touchscreen (not separately shown), which is a key element of the user interface 404 of the mobile device 208.

The mobile device 208 further includes a mobile processor/control circuit 406, which is contained within the housing 403. Also included in the mobile device 208 is a storage/memory device or devices (reference numeral 408). The storage/memory devices 408 are in communication with the processor/control circuit 406 and may contain program instructions to control the processor/control circuit 406 to manage and perform various functions of the mobile device 208. As is well-known, a device such as mobile device 208 may function as what is in effect a pocket-sized personal computer (assuming for example that the mobile device is a smartphone), via programming with a number of application programs, or “apps”, as well as a mobile operating system (OS). (The apps are represented at block 410 in FIG. 4, and may, along with other programs, in practice be stored in block 408, to program the processor/control circuit 406.) In accordance with aspects of the present disclosure, the apps 410 may include a wallet app 411 or other app that provides functionality so that the mobile device 208 can perform its role in transactions as described herein.

As is typical for mobile devices, the mobile device 208 may include mobile communications functions as represented by block 412. The mobile communications functions may include voice and data communications via a mobile communication network with which the mobile device 106 is registered. The mobile communication functions 412 may operate to allow the mobile device 208 to engage in data communications with the origination institution 304 (FIG. 3), as described herein.

Still further, the mobile device 208 may include a conventional digital camera 414 of the type commonly provided in smartphones or similar devices. As is frequently done with mobile devices, the camera 414 may be utilized to scan QR codes, including such codes employed in the payment account system 300 described herein.

From the foregoing discussion, it will be appreciated that the blocks depicted in FIG. 4 as components of the mobile device 208 may in effect overlap with each other, and/or there may be functional connections among the blocks which are not explicitly shown in the drawing. It may also be assumed that, like a typical smartphone, the mobile device 208 may include a rechargeable battery (not shown) that is contained within the housing 403 and that provides electrical power to the active components of the mobile device 208.

It has been posited that the mobile device 208 may be embodied as a smartphone, but this assumption is not intended to be limiting, as mobile device 208 may alternatively, in at least some cases, be constituted by a tablet computer or by other types of mobile computing devices.

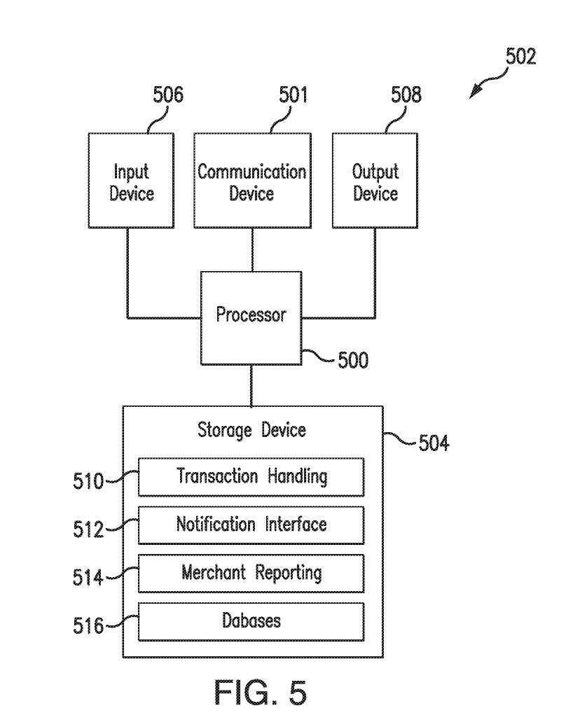

FIG. 5 is a block diagram representation of an embodiment of a computer system 502 which may be operated by or on behalf of the receiving institution (RI) 306 to provide functionality as described herein. The computer system 502 may accordingly be referred to as the “RI computer.” The RI computer 502 may be constituted by server computer and/or mainframe computer hardware.

The RI computer 502 may include a computer processor 500 operatively coupled to a communication device 501, a storage device 504, an input device 506 and an output device 508. The computer processor 500 may be in communication with the communication device 501, the storage device 504, the input device 506 and the output device 508.

The computer processor 500 may be constituted by one or more processors. Processor 500 operates to execute processor-executable steps, contained in program instructions described below, so as to control the RI computer 502 to provide desired functionality.

Communication device 501 may be used to facilitate communication with, for example, other devices (such as associates' mobile phones, and the payment network). For example communication device 501 may comprise numerous communication ports (not separately shown), to allow the RI computer 502 to communicate simultaneously with a large number of other devices, including communications as required to handle numerous transactions as described herein. The communication device 501 and the RI computer 502 may, for example, be configured to simultaneously handle hundreds or thousands of transactions.

Input device 506 may comprise one or more of any type of peripheral device typically used to input data into a computer. For example, the input device 506 may include a keyboard and a mouse. Output device 508 may comprise, for example, a display and/or a printer.

Storage device 504 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 504 stores one or more programs for controlling processor 500. The programs comprise program instructions (which may be referred to as computer readable program code means) that contain processor-executable process steps of the RI computer 502, executed by the processor 500 to cause the RI computer 502 to function as described herein.

The programs stored by the storage device 504 may include one or more operating systems (not shown) that control the processor 500 so as to manage and coordinate activities and sharing of resources in the RI computer 502, and to serve as a host for application programs that run on the RI computer 502.

The storage device 504 may also store a transaction handling application program 510. The transaction handling application program 510 may control the processor 500 to enable the RI computer 502 to handle transactions as described herein.

Moreover, the storage device 504 may store a software interface 512 that supports communication from the RI computer 502 to associates' mobile phones 206.

Still further, the storage device 504 may store a merchant reporting application program 514 which controls the processor 500 to enable the RI computer 502 to provide reports of transactions to merchants in a manner described herein.

The storage device 504 may further store an internal reporting application (both not separately shown), which may respond to requests from computer system administrators for reports on the activities performed by the RI computer 502; the storage device 504 may also store communication software, device drivers, etc.

The storage device 504 may also store one or more databases 516 required for operation of the RI computer 502.

Other computers that play a part in the system 300 may be similar in their hardware architecture and in their constituent hardware components to the RI computer 502 as just described. Such other computers may be programmed with different programs from those described above.

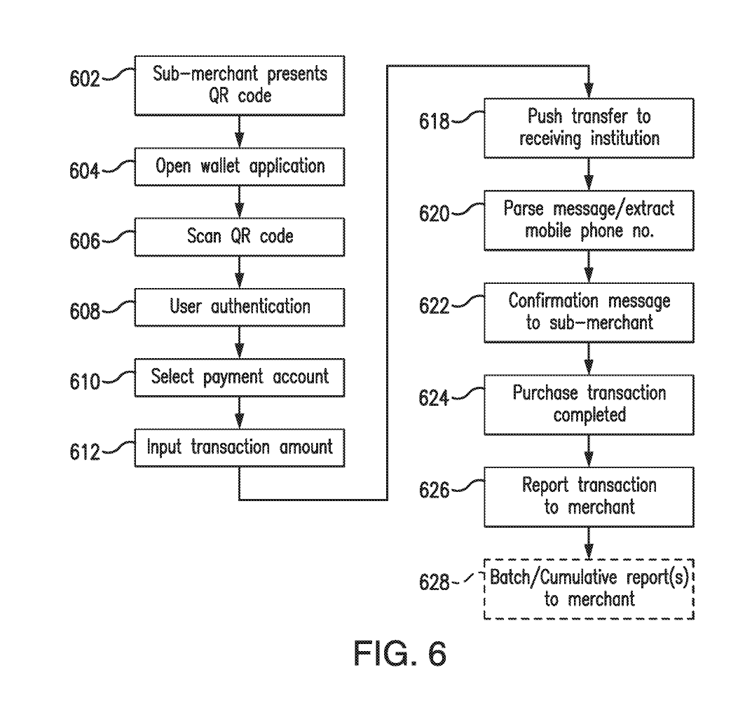

FIG. 6 is a flow chart that illustrates a process that may be performed according to aspects of the present disclosure. FIG. 6 may be considered to illustrate a payment account system transaction process, as per FIG. 3.

As background to this process, it may be assumed that the user 107 has visited a merchant's location, selected one or more items for purchase, and requested to purchase the items. The sub-merchant/associate 204 may have calculated a total amount due for the purchase transaction and informed the user 107 of the amount due.

At block 602 in FIG. 6, the sub-merchant may present or display the QR code 302 (FIG. 3) to the user 107, or may otherwise bring the QR code 302 to the attention of the user 107 (assuming the user 107 has not himself/herself noticed the QR code 302; in some environments the QR code 302 may be prominently displayed at a checkout counter or other point of sale).

At block 604 in FIG. 6, the user 107 may interact with the mobile device 208 to open the wallet app 411.

At block 606, the user 107 may use the wallet app 411 and camera 414 of the mobile device 208 to scan the QR code 302. The information obtained from the QR code may contain an indication as to whether the merchant has opted for (a) sub-merchant reporting for this sub-merchant, or (b) sub-merchant reporting and sub-merchant notification for this sub-merchant. The indication may, for example, be a two-digit indicator such as “01” in the former case and “02” in the latter case.

The information obtained from the QR code may also include a merchant identifier. If sub-merchant reporting and sub-merchant notification is indicated for this sub-merchant, then the information obtained from the QR code may also include a mobile phone number that is associated with the sub-merchant's mobile phone 206. As will be seen, this same mobile phone number may also be used to identify the sub-merchant for reporting purposes. If only sub-merchant reporting is indicated for this sub-merchant, then the information obtained from the QR code may include a numeric sub-merchant identifier (say, of up to 10 digits) that the merchant has assigned to the sub-merchant. For the most part, the ensuing discussion will assume that sub-merchant reporting and sub-merchant notification were indicated.

At 608, a user authentication procedure may be performed via the mobile device 208. This may involve the user entering a wallet PIN (personal identification number) and verification of the entered PIN. Alternatively, biometric user authentication (e.g., a fingerprint scan and verification) may be employed.

Assuming more than one payment card account has been registered with the wallet app 411, at block 610 the user may select a particular one of the payment card accounts to be utilized to settle the purchase transaction. Before or after selection of the payment card account for the current transaction, the mobile device 208 may display—to the user—information identifying the merchant as obtained from the scan of the QR code. On this basis, the user can confirm to the mobile device that the payment is to be made to the merchant as intended by the user.

At 612, the user may enter the total amount to be paid for the transaction. (In some embodiments, this step may be omitted, e.g., when the QR code is dynamic and includes the transaction amount.)

Following step 610 or 612, as the case may be, the origination institution app on the mobile device 208 has the information necessary to initiate a funds transfer transaction and communicates the information to the origination institution 304. This allows the origination institution 304, as indicated at block 618, to execute a payment account system “push” transaction to transfer the transaction amount from the user's payment account for the benefit of the merchant. The push transaction may be routed via the payment network 110a to the receiving institution 306. The push transaction may be executed using a payment account system message format. The reporting/reporting plus notification indicator and the sub-merchant identifier/sub-merchant mobile phone number may be included as respective data elements in the push transaction messaging.

It may be assumed that receiving institution 306 receives the push transaction message and verifies the merchant identifier. It may further be assumed that the receiving institution parses the message, determines that it contains the sub-merchant phone number, and extracts the sub-merchant phone number, as indicated at 620 in FIG. 6.

At 622, the receiving institution 304 may use the sub-merchant phone number to address and send a text message or the like to the sub-merchant's mobile phone 206 to confirm that the required payment account system transaction has occurred.

At 624, the sub-merchant 204 receives the confirmation message at his/her mobile phone 206 and allows the user/customer 107 to depart from the store premises with the purchased items, thereby completing the purchase transaction.

At 626 (and/or as part of a later batch process—block 628), the receiving institution 304 may notify/report to the merchant that the transaction has occurred. The reporting to the merchant with respect to the transaction may include the sub-merchant's mobile phone number so that the merchant can attribute the transaction to the sub-merchant and/or recognize the sub-merchant's involvement or role in the transaction.

With a process as described in FIG. 6, merchants' acceptance of payment account system transactions may be facilitated even in complex operations in which many different sub-merchants/associates may be handling transactions on behalf of the merchant in question. In the example use-case described in connection with FIG. 6, the transaction may take place in a merchant's “brick and mortar” retail store location. At that location, many sales associates may be assigned to assist customers and engage in sale/purchase transaction with customers. The customers may settle the transactions with payment account system transactions launched from the customer's payment-enabled mobile devices by scanning a QR code associated with the sub-merchant who is assisting the customer. The sub-merchants need not have anything like a conventional POS terminal to handle the transaction. Also, the sub-merchant need not handle transactions at a fixed location in the store. Instead, the sub-merchants may merely have a mobile phone (their own or store supplied, not necessarily a smartphone so long as it is capable of receiving a text message) and a suitable QR code printed on a sticker, placard or other substrate for the sub-merchants to present for reading by the customer's payment-enabled mobile device. From the discussion above of FIG. 6, it will be appreciated that the sub-merchant's mobile phone number is included in the QR code data and passed by suitable messaging through the payment account system to the merchant's bank (receiving institution). The merchant's bank then confirms to the sub-merchant's mobile phone that the payment transaction has taken place.

In another, rather similar use case, the transaction may occur at the customer's home or office and the sub-merchant may be a delivery person who is servicing a delivery route (e.g., furniture delivery, pizza delivery, parcel delivery). The sub-merchant may be an employee of the merchant. Alternatively, the sub-merchant may be employed by a parcel delivery company or the like (retained by the merchant for delivering an ordered item to the customer) and may engage in a C.O.D. transaction on the merchant's behalf.

In some use cases, the sub-merchant may present the QR code to the customer's payment enabled mobile device by displaying it on a display screen of a mobile terminal/mobile device carried by the sub-merchant. In such cases, the QR code may, but need not, be dynamic. With a dynamic QR code, the information obtained by scanning the QR code may include, for example, the transaction amount. In this use case, step 612 shown in FIG. 6 may be obviated.

In another use case, the merchant may be a restaurant and the sub-merchants may be members of the wait-staff. It will be appreciated that the payment account system transaction may be launched and completed with the customer and the sub-merchant present at the customer's table.

Other advantages presented by processes as described herein include extensive reporting of transactions to merchants from their banks, detailed to the employee/associate level. For example, where the merchant is a restaurant, the reports may provide periodic aggregate totals of the revenues brought in by each member of the wait-staff. In the restaurant use case, accounting for and payment of tips may also be supported. The reporting in this and/or other use cases may be in batch form and/or cumulative as to employee/associate, store, in-store location or department, and/or time period, etc.

Still another advantage is that the merchant need not inform the merchant's bank or any other entity when a new associate is added or an associate leaves the merchant's employ. A new associate may be incorporated in the payment account system operations simply by the merchant printing/providing a QR code that represents in its data the new associate's mobile phone number. Moreover, the process as described herein is highly scalable. A single receiving institution can readily serve thousands of merchants via processes such as that illustrated in FIG. 6. The merchant can operate with thousands of sub-merchants, all conveniently identified and notified for transaction completion via the sub-merchants' mobile phone numbers. At the same time, the process as described herein may also be quite suitable and convenient to implement for a small merchant with only one or a few sub-merchants.

In other use cases, instead of notification to the sub-merchant by text message, the transaction confirmation message may be sent as an email message, or via “in app” messaging if the sub-merchant has a suitable smartphone running the appropriate application program.

In an embodiment described above, the indicator for reporting vs. reporting plus sub-merchant notification was included in the QR code and/or in the payment account system messaging as a separate data element from the sub-merchant identifier/mobile phone number. However, in another embodiment, to promote data efficiency, both the indicator and the sub-merchant identifier/phone number may be included together in the same data element. For example, the former may be concatenated with the latter. In this embodiment, e.g., the first two digits of the data element may be read, and as a result of reading these two digits (i.e., the indicator) it may be determined (e.g., at the payment network 110a or the receiving institution 306) that the balance of the data element contains the mobile phone number for the sub-merchant. If this determination is made at the payment network, the latter may repackage the indicator and the sub-merchant phone number as separate data elements for messaging to the receiving institution.

The process described in FIG. 6 is an example of one transaction that may be performed involving the merchant and a particular customer. Numerous similar transactions may of course be performed at various times involving the same merchant (and the same receiving institution) and different customers, with each of the transactions charged to the respective different payment accounts of those customers. Moreover, at least some of the other similar transactions may involve different associates from the associate involved in the example transaction illustrated in FIG. 6. Where other associates are involved, other QR codes, and the different mobile phone numbers for the other associates, may be used for messaging during the transaction, including the confirmation messaging to the other associates' mobile phones.

In example embodiments described herein, QR codes were scanned by the customer's mobile device to launch the payment account system transaction. Alternatively, however, a type of barcode or symbology other than QR codes may be employed. For example, a string of alphanumeric characters may be scanned by the customer's mobile device to launch the payment account system transaction. In some embodiments, the associate mobile phone numbers referred to herein may include country dialing codes to facilitate international operation of the payment account system 300.

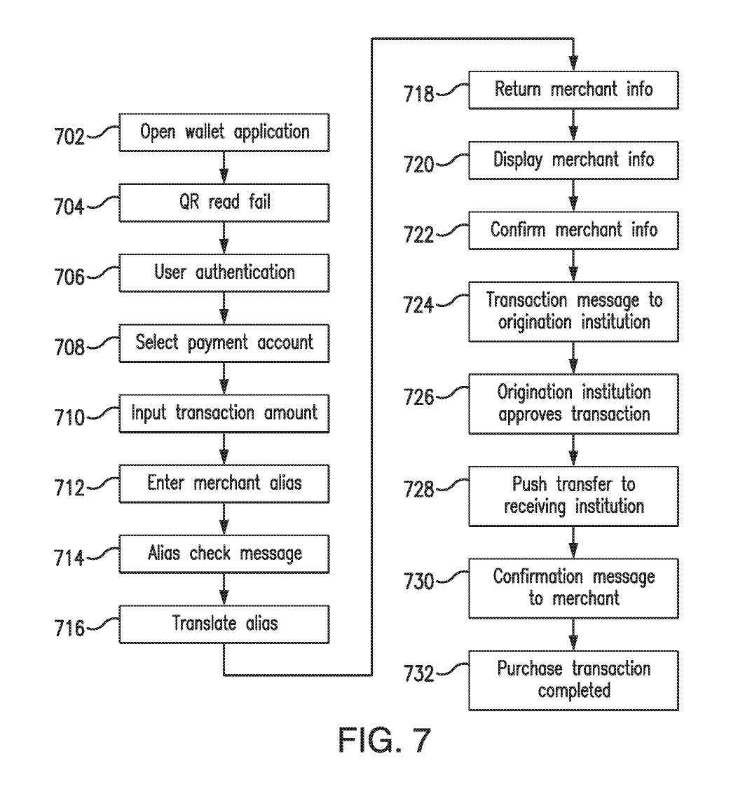

In other embodiments and/or in other situations, a QR-scan-launched payment account transaction may be attempted unsuccessfully, or may not be possible for some reason, and a process as described in FIG. 7 may take place.

FIG. 7 is a flow chart that illustrates a process performed in accordance with teachings of this disclosure.

As background to this process, it may be assumed that a user/customer has visited a merchant's location, selected one or more items for purchase, and requested to purchase the items. A check-out clerk may have calculated a total amount due for the purchase transaction and informed the user of the amount due. Notification to or identification of an individual sub-merchant need not play a role in the process of FIG. 7.

At block 702 in FIG. 7, the user may interact with his/her payment-enabled mobile device to open a wallet app running on the mobile device.

At block 704, the user may attempt to scan a QR code presented at the point of sale, but the scan may fail. Alternatively, the user may be aware ahead of time that his/her mobile device lacks the capability to scan a merchant's QR code.

At block 706, a user authentication procedure may be performed via the mobile device. This may involve the user entering a wallet PIN (personal identification number) and verification of the entered PIN. Alternatively, biometric user authentication (e.g., a fingerprint scan and verification) may be employed.

Assuming more than one payment card account has been registered with the user's wallet app, at block 708 the user may select a particular one of the payment card accounts to be utilized to settle the purchase transaction.

At block 710, the user may enter the total amount to be paid for the transaction. (In some embodiments, this step may be omitted, e.g., when the QR code is dynamic and includes the transaction amount.)

At block 712, the user may manually enter into the mobile device a merchant alias that is printed or displayed in human-readable form together with the QR code referred to in the above discussion of block 704. The merchant alias may be, for example, a string of numeric characters.

At block 714, the wallet app may control the mobile device to send a message to a remote server computer (e.g., operated by or associated with the payment network) to transmit the merchant alias to the remote server computer (at least nominally, the remote server computer may be deemed represented by the payment network 110a in FIG. 3).

At block 716, the remote server computer may reference a directory or look-up table to translate the merchant alias into the merchant's name and identifier for the payment account system.

At block 718, the remote server computer may transmit a message back to the user's mobile device to indicate the translated merchant's name and identifier. The latter message may also identify the merchant's bank (i.e., the prospective receiving institution).

At block 720, the user's mobile device may display the merchant's name to the user. In this way, the user is able to confirm that he/she properly entered the merchant alias at block 712, so that the transaction benefits the intended merchant. The user may indicate this confirmation by input to the mobile device, as indicated at block 722.

At block 724, the wallet app may control the mobile device such that it engages in communications with the user's origination institution. The mobile device accordingly may transmit, and the origination institution may receive, the information required to launch a push transaction, including the merchant I.D. and the receiving institution I.D. as received from the remote server by the mobile device.

At 726, the origination institution uses the information received at 724 to determine whether to go forward with the requested transaction (e.g., the origination institution may determine whether the user's payment account is in order and has a sufficient available balance/available credit to support the requested transaction; the origination institution may also apply fraud management processes). For purposes of subsequent discussion, it is assumed that the origination institution ok's the transaction and proceeds to execute it, as indicated at 728.

At 728, the origination institution executes a payment account system “push” transaction to transfer the transaction amount from the user's payment account for the benefit of the merchant. The push transaction may be routed via the payment network to the receiving institution. The push transaction may be executed using a payment account system message format. It may be assumed that receiving institution receives the push transaction message and verifies the merchant identifier.

At 730, the receiving institution may send a message to the merchant to confirm that the required payment account system transaction has occurred. At 732, the merchant receives the confirmation message and allows the user/customer to depart from the store premises with the purchased items, thereby completing the purchase transaction.

In embodiments described above, a customer's device (e.g., a mobile device 206) scanned a QR code to obtain transaction information such as sub-merchant identifier/phone number, merchant i.d., and perhaps transaction amount as well. In other embodiments, however, the customer's device may alternatively receive such information by wireless radio communication (e.g., via NFC, RFID, Bluetooth, WiFi or the like). Such radio communication may be transmitted to the customer's device by, e.g., an associate's device (e.g., a phone 206), a merchant's device (e.g., a POS terminal or tablet computer/smartphone programmed to service as a POS terminal), a radio beacon (which may be, in one embodiment, an RFID tag), etc.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

As used herein and in the appended claims, a “server” includes a computer device or system that responds to numerous requests for service from other devices.

The flow charts and descriptions thereof herein should not be understood to prescribe a fixed order of performing the method steps described therein. Rather, the method steps may be performed in any order that is practicable, including simultaneous performance of at least some steps.

As used herein and in the appended claims, the term “payment card system account” includes a credit card account, a deposit account that the account holder may access using a debit card, a prepaid card account, or any other type of account from which payment transactions may be consummated. The terms “payment card system account” and “payment card account” and “payment account” are used interchangeably herein. The terms “payment card system” and “payment account system” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card, debit card, prepaid card, or other type of payment instrument, whether an actual physical card or virtual.

As used herein and in the appended claims, the term “payment system” or “payment account system” refers to a system for handling purchase transactions and related transactions. An example of such a system is the one operated by MasterCard International Incorporated, the assignee of the present disclosure. In some embodiments, the term “payment system” may be limited to systems in which member financial institutions issue payment accounts to individuals, businesses and/or other organizations.

Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A method comprising:
receiving a first payment account system transaction message, the first payment account system transaction message for executing a first payment account system transaction charged to a first payment account to benefit a merchant, the first payment account system transaction message including a first mobile telephone number that identifies a first associate of the merchant;
in response to receiving the first payment account system transaction message, sending a first confirmation message for receipt by a first mobile device used by the first associate, the first confirmation message being addressed for routing to the first mobile device by use of the first mobile telephone number, the first confirmation message for notifying the first associate that the first payment account system transaction has occurred;
receiving a second payment account system transaction message, the second payment account system transaction message different from the first payment account system transaction message, the second payment account system transaction message for executing a second payment account system transaction charged to a second payment account to benefit said merchant, the second payment account different from the first payment account, the second payment account system transaction message including a second mobile telephone number that identifies a second associate of the merchant, the second associate different from the first associate; and
in response to receiving the second payment account system transaction message, sending a second confirmation message for receipt by a second mobile device used by the second associate, the second mobile device different from the first mobile device, the second confirmation message different from the first confirmation message, the second confirmation message being addressed for routing to the second mobile device by use of the second mobile telephone number, the second confirmation message for notifying the second associate that the second payment account system transaction has occurred.

2. The method of claim 1, further comprising:
reporting said first payment account system transaction to said merchant in association with said first mobile telephone number.

3. The method of claim 2, wherein said reporting step includes sending a batch file to the merchant.

4. The method of claim 2, wherein said reporting step includes sending a cumulative transaction report to the merchant.

5. The method of claim 2, further comprising:
reporting said second payment account system transaction to said merchant in association with said second mobile telephone number.

6. The method of claim 1, wherein the first mobile telephone number is received as at least part of a data element in the first payment account system transaction message.

7. The method of claim 6, wherein the data element contains an indicator that indicates that the data element includes the first mobile telephone number.

8. The method of claim 7, wherein the indicator is concatenated with the first mobile telephone number.

9. A method comprising:
receiving a first payment account system transaction message, the message containing a combined data element, the combined data element containing an indicator concatenated with a mobile telephone number;
reading the indicator from the received first payment account system transaction message;
in response to reading the indicator, extracting the mobile telephone number from the combined data element;
including the mobile telephone number in a non-combined data element in a second payment account system transaction message; and
routing the second payment account system transaction message to a receiving institution, the routed second payment account system transaction message including said non-combined data element.

10. The method of claim 9, wherein said non-combined data element includes only said mobile telephone number.

11. The method of claim 10, wherein:
said first payment account system transaction message includes a merchant identifier; and
said second payment account system transaction message includes said merchant identifier.

12. The method of claim 11, wherein said receiving institution performs payment account system transaction acquiring services for a merchant identified by said merchant identifier.

13. A method of engaging in a purchase transaction with an associate of a merchant, the method comprising:
using a first mobile device to scan a barcode presented by the associate;
extracting a merchant identifier and a mobile telephone number from the scanned barcode, the merchant identifier associated with the merchant;
transmitting a transaction request message from the first mobile device to an originating financial institution, the transaction request message including the merchant identifier and the mobile telephone number; and
completing the purchase transaction upon the associate receiving a confirmation message on a second mobile device in possession of the associate, the confirmation message addressed to the second mobile device by using the mobile telephone number.

14. The method of claim 13, wherein the transaction request message includes a transaction amount.

15. The method of claim 14, wherein the transaction amount is extracted from the scanned barcode.

16. The method of claim 14, wherein the transaction amount was manually entered into the first mobile device.

17. The method of claim 13, wherein the barcode is a QR (quick response) code.

18. The method of claim 13, wherein the associate is a delivery person employed by the merchant and said scanning step occurs at a stop on a delivery route serviced by the associate.

19. The method of claim 13, wherein the associate is a sales associate located at a check-out counter in a retail store operated by the merchant.

20. The method of claim 13, wherein the associate is a wait-staff member at a restaurant operated by the merchant.
